(19) United States
(12) Patent Application Publication
(10) Pub. No.: US 2007/0112604 A1
(43) Pub. Date: May 17, 2007

(54) Computer system managing an insurance reserve requirement by segmenting risk components in a reinsurance transaction

(76) Inventors: Crispina O. Caballero, Stouffville (CA); Thomas F. Conroy, Englewood, CO (US); Steven A. Eisenberg, Atlanta, GA (US); Brian G. Holland, Needham, MA (US); Stephen F. Kraysler, Hull, MA (US); Richard W. Mann, Greensboro, NC (US); Charles M. Underwood II, Weymouth, MA (US)

Correspondence Address: Peter K Trzyna, P O Box 7131, Chicago, IL, 60680-7131, US

(21) Appl. No.: 10/581,419

(22) PCT Filed: Nov. 4, 2004
(86) PCT No.: PCT/US04/37000

§ 371 Date: Nov. 14, 2006

Related U.S. Application Data
(60) Provisional application No. 60/517,180, filed on Nov. 4, 2003.
(60) Provisional application No. 60/603,608, filed on Aug. 23, 2004.

(51) Int. Cl. G06Q 40/00

(52) U.S. Cl. 705/4; 705/35

(57) ABSTRACT

Apparatus (method implemented with a machine, the machine, and the method for making the machine, and products produced thereby). The computer system can, for example, be structured (e.g., including programmed) to carry out the steps of: calculating an insurance reserve requirement from data; segmenting, for the reserve requirement, an insured contingency risk from a corresponding capital requirement to produce components; and carrying out the reinsurance transaction by steps including: allocating the components to different parties, one of the parties from a group including an insurance risk carrier and a source of an asset for said capital requirement; and assigning assets for the reserve requirement to a reinsurance asset trust to receive reinsurance credit for said reserve requirement.

This patent application claims priority from, and incorporates by reference, U.S. Patent Application Ser. No. 60/517,180 titled, “Computer System for Redundant Insurance Reserve Financing,” filed Nov. 4, 2004, and U.S. Patent Application Ser. No. 60/603,608 titled “Computer System for Redundant Insurance Reserve Financing,” filed Aug. 23, 2004.

### I. TECHNICAL FIELD

The technical field is computers and data processing systems. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of managing risk components in a reinsurance transaction.

### II. BACKGROUND ART

Illustratively, the adoption of Regulation XXX by U.S. state insurance regulators significantly increased the statutory reserves required for Level Premium Term Life and certain guarantee riders for Universal Life policies. A portion of these reserves are generally considered to be “redundant”, or an excess of the total basic reserve as defined under Regulation XXX over the “economic reserve”, which is defined as the GAAP reserve. The redundant reserves are released back into capital at the time a policy experiences a death claim or terminates by lapse, because term insurance and the riders have no cash surrender value. The reserves are far in excess of those required for the same policies in other jurisdictions.

For policy pricing purposes, these redundant reserves are capital investments and require a “hurdle rate” return, so pricing of Level Term insurance and certain Universal Life products were affected when the Regulation was adopted. Since term life insurance is a very price competitive product, most carriers were reluctant to raise prices and therefore looked to transfer the redundant reserves to reinsurers. The redundant reserves problem is especially acute for level term products with durations exceeding ten years.

Reinsurers were willing to accept these reserves for a fee as they could, either directly or indirectly, move the policies to other non-U.S. jurisdiction where the higher reserves dictated by Guideline XXX were not required. The reinsurer ending up with the policies could not be licensed in the US, however, as that would require them to post the reserves in their US Statutory statement. Therefore, the reserves wound up in an “unauthorized reinsurer”, which is generally an offshore insurance company.

For the US ceding insurer (i.e., the original writing carrier) to be able to take credit for the reinsurance in its statutory statement, however, the unauthorized reinsurer is required to post collateral equal to the reserves for which the cedant is taking credit. The reinsurers typically used Bank Letters of Credit (LOC) which met the statutory rules of the states to collateralize the agreement.

Similar situations exist in countries other than the United States, for example, Canada.

Letters of Credit are not the only way these reinsurance contracts can be collateralized. The states also allow credit when the collateral is assets in trust for the benefit of the cedant under the reinsurance treaty. The assets would be assets that qualify as admitted assets in a US Life Insurance Company. This would include investment grade bonds, Collateralized Mortgage Obligations's (CMO), Mortgage Backed Securities's (MBS) and very limited amounts of Real Estate and Equities. The terms of the trust meet the statutory rules. Stringent trust rules include those promulgated by the state of New York.

This alternative, funding a trust with qualifying assets, has not been widely used. First the offshore entities that are used for this reinsurance typically are subsidiaries of the reinsurer and are not as large or highly capitalized, so they don't have the assets to contribute to the trust structure. Secondly, the trust requires some administration and management while providing LOC's do not. Third, LOC's were cheap. Recently, however, LOC's have become more scarce and prices are increasing. Since LOC's renew and reprice annually, this market change affects not just new business, but also business already reinsured.

There are several sources of Trust assets used by the reinsurer, for example, assets from its own portfolio, assets loaned to it by others or assets purchased with the proceeds from the issuance of securities, funding agreements (FA), Capital Redemption Bonds (CRB), and Guaranteed Investment Contracts (GIC) by the reinsurer or a Special Purpose Entity created for that purpose. The various types of securities, FA's, CRB's, and GIC's are collectively referred to as trust funding financial instruments.

In carrying out the foregoing, in addition to the different focused computer structuring, there have been significant needs regarding such as efficiency and/or security, with manual systems being prone to manual problems, and with automated variants having limitations regarding control and management of corresponding computer resources.

### III. DISCLOSURE

In the area of said technical field, representatively, consider a computer system (illustratively representing, for the sake of brevity, methods, articles of manufacture, transmitter, receiver, network implementations, etc.) structured to aid managing an insurance reserve requirement by segmenting risk components in a reinsurance transaction. The computer system can, for example, be structured (e.g., including programmed) to carry out the steps of: calculating an insurance reserve requirement from data; segmenting, for the reserve requirement, an insured contingency risk from a corresponding capital requirement to produce components; and carrying out the reinsurance transaction by steps including: allocating the components to different parties, one of the parties from a group including an insurance risk carrier and a source of an asset for said capital requirement; and assigning assets for the reserve requirement to a reinsurance asset trust to receive reinsurance credit for said reserve requirement. Consider too a computer system comprising means for calculating an insurance reserve requirement from data; means for segmenting, for the reserve requirement, an insured contingency risk from a corresponding capital requirement to produce components; and means for carrying out the reinsurance transaction by means including: means for allocating the components to different parties, one of the parties from a group including an insurance risk carrier and a source of an asset for said capital requirement; and means for assigning assets for the reserve requirement to a reinsurance asset trust to receive reinsurance credit for said reserve requirement. Consider further a computer apparatus arranged for controlling a system carrying out an implementation of managing an insurance reserve requirement by segmenting risk components in a reinsurance transaction, the apparatus including: a computer system arranged to receive data and locate said data into a memory; calculating means for calculating said insurance reserve requirement; program control means for segmenting, for said reserve requirement, said insured contingency risk from a corresponding capital requirement to produce components; program control means for carrying out said reinsurance transaction; program control means for allocating said components to different parties, one of the parties from a group including an insurance risk carrier and a source of an asset for said capital requirement; and program control means for assigning assets for the reserve requirements to said reinsurance asset trust to receive reinsurance credit for said reserve requirement.

### IV. BRIEF DESCRIPTION OF THE DRAWINGS

FIG. 1 illustrates an overview of an embodiment.

FIG. 2 is a diagram representing the computer system of an embodiment.

FIG. 3 is a flowchart showing the logic of the logic means for controlling the computer system in accordance with an embodiment.

FIG. 4 shows a combination of FIGS. 4a-4c.

FIG. 4a, which continues to FIG. 4c, represents a portion of a flowchart showing the data input, computational and other logic, and the data output of the logic means for controlling the computer system in accordance with an embodiment.

FIG. 4b is a continuation of FIG. 4a, and represents a portion of a flowchart showing the data input, computational and other logic, and the data output of the logic means for controlling the computer system in accordance with an embodiment.

FIG. 4c is a continuation of FIG. 4b, and represents a portion of a flowchart showing the data input, computational and other logic, and the data output of the logic means for controlling the computer system in accordance with an embodiment.

FIG. 5 shows a combination of FIGS. 5a-5e.

FIG. 5a, which continues to FIG. 5c, represents a portion of a flowchart showing the data input, computational and other logic, and the data output of the logic means for controlling the computer system in accordance with an embodiment applied to issuing securities.

FIG. 5b is a continuation of FIG. 5a, and represents a portion of a flowchart showing the data input, computational and other logic, and the data output of the logic means for controlling the computer system in accordance with an embodiment applied to funding the capital requirement by issuing securities.

FIG. 5c is a continuation of FIG. 5b, and represents a portion of a flowchart showing the data input, computational and other logic, and the data output of the logic means for controlling the computer system in accordance with an embodiment applied to funding the capital requirement by issuing securities.

FIG. 5d is a continuation of FIG. 5c, and represents a portion of a flowchart showing the data input, computational and other logic, and the data output of the logic means for controlling the computer system in accordance with an embodiment applied to funding the capital requirement by issuing securities.

FIG. 5e is a continuation of FIG. 5d, and represents a portion of a flowchart showing the data input, computational and other logic, and the data output of the logic means for controlling the computer system in accordance with an embodiment applied to funding the capital requirement by issuing securities.

FIG. 6 shows a combination of FIGS. 6a-6c.

FIG. 6a, which continues to FIG. 6c, represents a portion of a flowchart showing the data input, computational and other logic, and the data output of the logic means for controlling the computer system in accordance with an embodiment applied to a reinsurance company managing the reinsurance transaction.

FIG. 6b is a continuation of FIG. 6a, and represents a portion of a flowchart showing the data input, computational and other logic, and the data output of the logic means for controlling the computer system in accordance with an embodiment applied to a reinsurance company managing the reinsurance transaction.

FIG. 6c is a continuation of FIG. 6b, and represents a portion of a flowchart showing the data input, computational and other logic, and the data output of the logic means for controlling the computer system in accordance with an embodiment applied to a reinsurance company managing the reinsurance transaction.

FIG. 7 is a graphic representation of interrelated computer systems in accordance with an embodiment.

FIG. 8 is a graphic representation of a funding agreement in accordance with an embodiment.

FIG. 9 illustrates a flowchart for an embodiment.

### V. MODES

The accompanying drawings illustrate embodiments intended to illustrate and exemplify in a teaching manner.

As used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow or “logic means” can be implemented in discrete circuits, programmed computer, or the equivalent. Computer-readable media, as used herein can comprise at least one of a RAM, a ROM, A disk, an ASIC, and a PROM. Industrial or technical applicability is clear from the description, and is also indicated below.

By way of the following prophetic teaching, there can be computer support, as in a data processing system, for implementing parts of, or from, a financial product or instrument to accomplish certain financial objectives to and advance such as efficiency and/or security, over said manual systems and corresponding problems, and automated variants having limitations regarding management of corresponding computer resources.

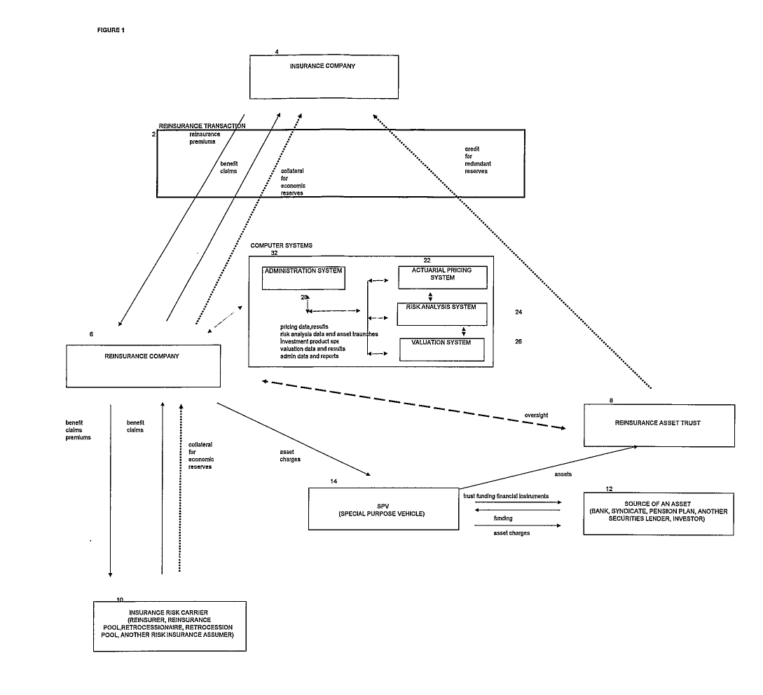

First, though, consider some context. In general, FIG. 1 illustrates the nature of the financial innovation that can give rise to a need for that which is set forth below.

Under United States statutory reserving procedures, for example, certain products with long term premium guarantees, for example level premium term and level cost of insurance universal life policies, are required to set up significantly higher reserves than economic reserves would call for. The amounts above the economic reserve, while required, are considered redundant and not necessary, except under extreme and unrealistic conditions.

However, the inventors observed that a Reinsurance Transaction 2 between an Insurance Company 4 and a Reinsurance Company 6 can be carried out such that in exchange for reinsurance premiums, the insurance company receives something else, such as benefit claims, and credit and related collateral for economic reserves and for redundant reserves. The Reinsurance Company 6, aided by Computer Systems 32, e.g., in cooperation with such as an Administration System 28, Actuarial Pricing System 22, Risk Analysis System 24 and Valuation System 26, handles segmenting the insurance contingency risk from the capital requirements. The insurance contingency risk can be ceded to an Insurance Risk Carrier 10, which provides benefit claims and collateral for the economic reserve in exchange for the benefit claims premiums. Through a SPV (Special Purpose Vehicle) 14, trust funding financial instruments can be issued to a Source Of An Asset 12 which then provides the funding or allows the assigning of assets to a Reinsurance Trust 8 in exchange for asset charges. The Reinsurance Company 6 also can provide oversight to the Reinsurance Trust 8. The assets in the Reinsurance Trust 8 allow the Insurance Company 4 to take credit for the redundant reserves. The Computer Systems 32 includes a Risk Analysis System 24 that can calculate the relative proportions and the pricing of any traunches of trust funding financial instruments.

Consider now more particularly a computer system managing fluctuating reserve requirements and the related reinsurance trust(s) and trust(s) funding financial instruments (or a similar financial vehicle to maintain the assets) requirements. In general, uncertain events that can be measured using statistical or actuarial methodologies but are not certain in timing and/or amounts, and such events are uncontrolled by the parties, can produce financial results that may vary from expected results.

Reinsurance reserve requirements vary from period to period based upon emerging experience. As such, reserve requirements also change based upon the experience. In addition, values of reinsurance reserves trusts are calculated using market values of the securities on the date of the financial statements currently filed. Maintaining the appropriate levels of investments contained in the reinsurance trusts requires a myriad of interrelated detailed calculations to determine the amounts to be added or removed from the trusts each reporting period, usually the calendar quarter.

The reinsurance transaction requirement is to find an appropriate asset source(s), an appropriate insurance risk assumer(s), an appropriate unauthorized reinsurer, and an appropriate ceding insurance company(s).

Once done, the business to be reinsured can be evaluated and priced, both economically and statutorily, using electronic computer based pricing programs; the appropriate insurance risk premiums can be calculated; the expected reserve requirements can be calculated using electronic computer analysis of inputted data; the value of the economic and excess reserves can be calculated by electronic computer programs to determine the value required for the trust; should multiple traunches of trust funding financial instruments be necessary the relative proportions of each traunche can be calculated using proprietary risk analysis software and these calculations can be made at the end of each reporting period (usually every 90 days), with appropriate adjustment to the contents of the trust(s).

The computer systems can also produce periodic reports (at least quarterly) on current reserve requirements, current trust values, current trust value requirements and reinsurance premiums and claims for the period.

In addition, the computer-based systems can produce all contracts between the participating parties.

For example, this approach can be used to manage the fluctuating reserve requirements under Guideline XXX for establishing statutory reserves for guaranteed level premium products (both term and universal life) in the U.S. Life Insurance market. In some jurisdictions, the reinsurer is only required to post economic reserves. A Reinsurance Company can segment the insurance risks from the capital requirements and manage each risk component with the most efficient party. The insurance risks can be moved to a Reinsurer (s), Retrocessionnaire (s), a Retrocession Pool, or another insurance risk assumer. The capital requirements can be funded thru a Bank, Syndicate, Pension Plan, another Securities Lender, or an investor through the purchase of any portion of any traunche of trust funding financial instruments. As such the ceding Life Insurance Company can receive the mortality risk protection as well as the collateral and related reinsurance credit for the economic reserve and the credit for the redundant reserves, as well as the reinsurance credit for the Statutory Risk Based Capital efficiently thru the Reinsurance Company.

Computer System

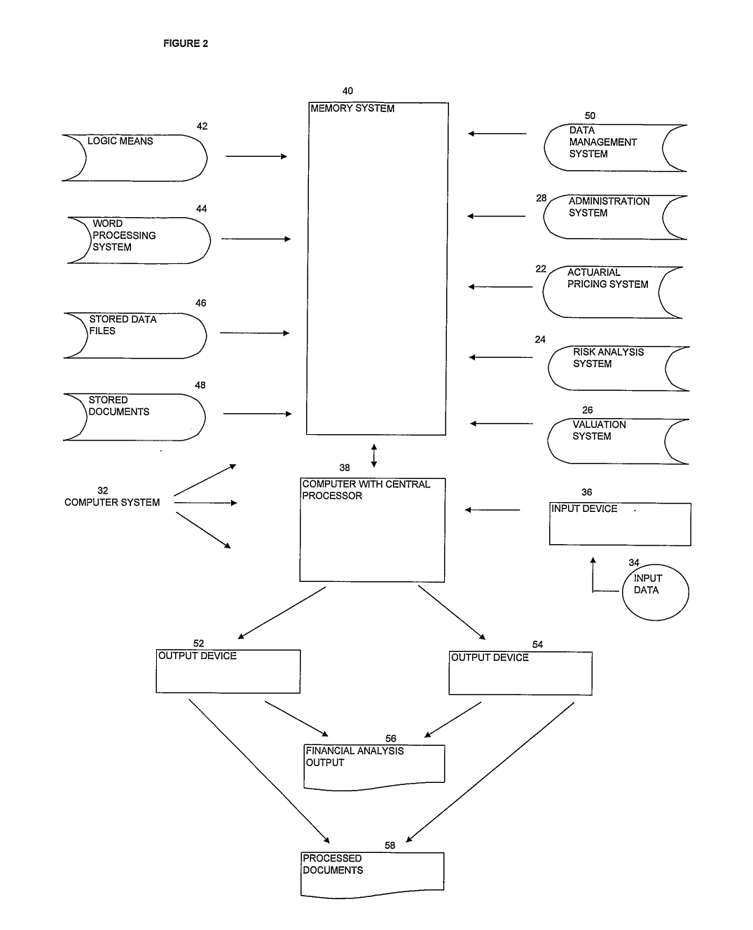

FIG. 2 provides a graphic representation of an exemplary computer system managing an insurance reserve requirement.

Consider, more particularly, a Computer System 32 (i) that manipulates signals comprising (a) Input Data 34 pertaining to data for the Reinsurance Transaction 2, (b) documents such as Stored Documents 48, and/or (c) previously encoded and processed data Stored Data Files 46; and/or (ii) that transforms these signals into analyses of the data; and/or (iii) that documents the results in Financial Analysis Output 56; and/or (iv) that illustrates selected results in Processed Documents 58.

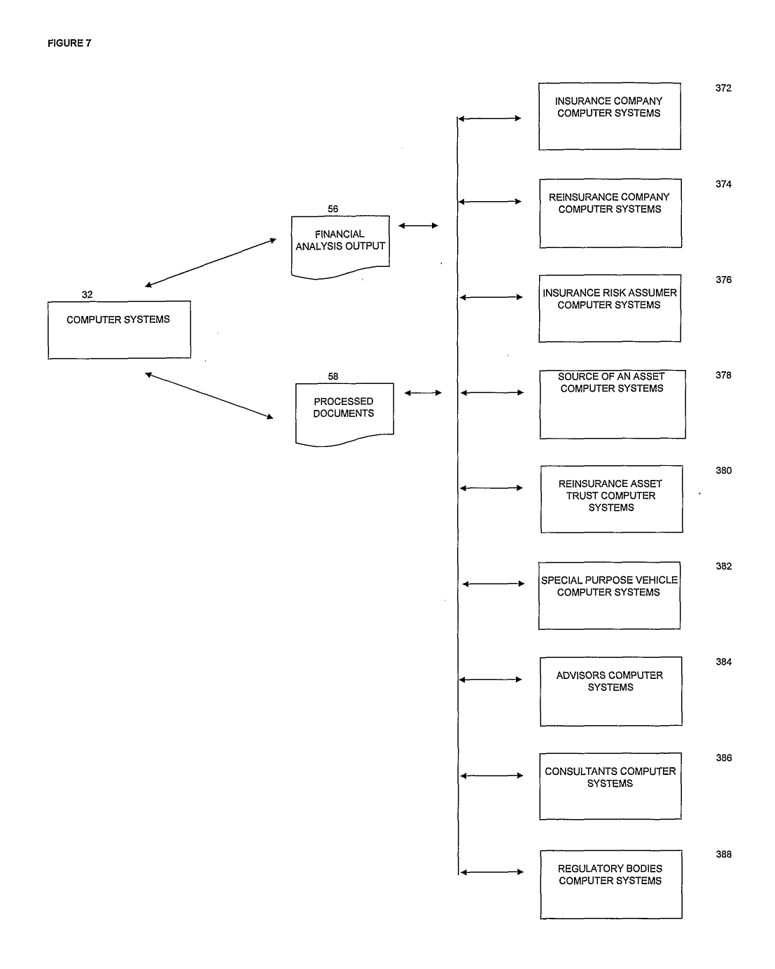

The Computer System 32 can comprise a Computer (e.g., an IBM, Hewlett Packard, or other personal computer) With Central Processor 38 58 (e.g., an Intel series processor or the like), a Memory System 40 (such as a hard drive, disk drive, etc.), an Input Device 36 (keyboard, mouse, modem, or the like), and one or more output devices, Output Device 52 and Output Device 54 (e.g., a Hewlett Packard printer, a Dell monitor, a modem, or other such output device). The Memory System 40 includes an operating system Logic Means 42 such as Microsoft XP Professional (and its applications such as EXCEL, ACCESS, and WORD) to run the Computer System 32, a Word Processing System 44 such as Microsoft Word to process transaction data, and results into Processed Documents 58. The Input Device 36 such as a keyboard receives Input Data 34 either manually or electronically. Output Device 52 and Output Device 54, such as a printer or a CD drive; produce such relevant documents as the Financial Analysis Output 56. Financial Analysis Output 56, including the input data, processed results, and other relevant information as well as processing logic, is normally shared via a network of computers as indicated in FIG. 7 (Computer System 32, and computer systems, Blocks 372-388, of parties involved such as Insurance Company, Reinsurance Company, Insurance Risk Assumer, Source Of An Asset, Reinsurance Asset Trust, Special Purpose Vehicle, Advisors, Consultants and Regulatory Bodies) and technical discussions occur until desired results are processed and illustrated formally in Processed Documents 58.

Logic Means

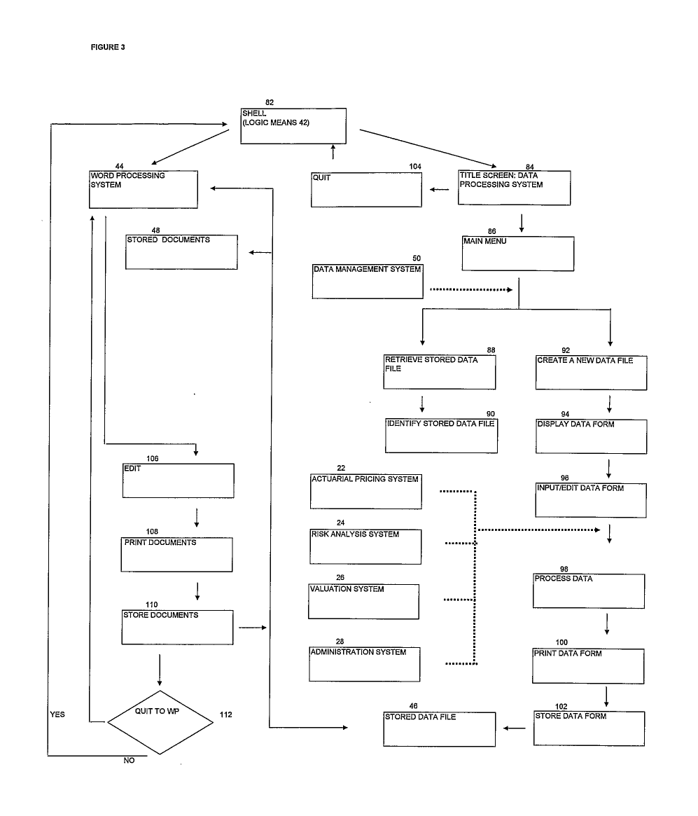

FIG. 3 is a flowchart of the overall operational processes for Computer System 32.

Logic Means 82 allows for two pathways, one for processing data, using Title Screen Data Processing System 84, and the other for processing model documents, using Word Processing System 44.

Title Screen Data Processing System 84 (which could be a coded or programmed EXCEL application, or an application that allows processing of numbers and logical evaluations; as reflected by logic behind a control system such as Main Menu 86 that can allow for the processing of information for the embodiment and controlling the system or part thereof, as may be desired), enables the creation of new data file (Block 92), update of existing data file (Block 88, retrieval of data file and Block 90, identification of data file), processing the data (Blocks 94-98, display and input/edit of data form then processing of data), printing the data information (Block 100) and storing the data (Blocks 102, 46-48, store data form, stored data file and stored documents). Data files are maintained historically, per contract, from its effective date. Data storage is physically in the computer or in a computer readable file kept offsite.

Word Processing System 44 allows for creating blank documents (Blocks 48), editing existing documents for any updates (Block 106), printing such results (Block 108) and storing different versions of documents (Block 110).

The Logic Means 42 allows for continuing processing in Blocks 84,86 and 112 (thru the title screen, main menu and the logic to continue with the word processing program) as well as for finalization of the process thru Blocks 104 and 112 (through the quit routine in the title screen and the logic to quit with the word processing program).

General Example

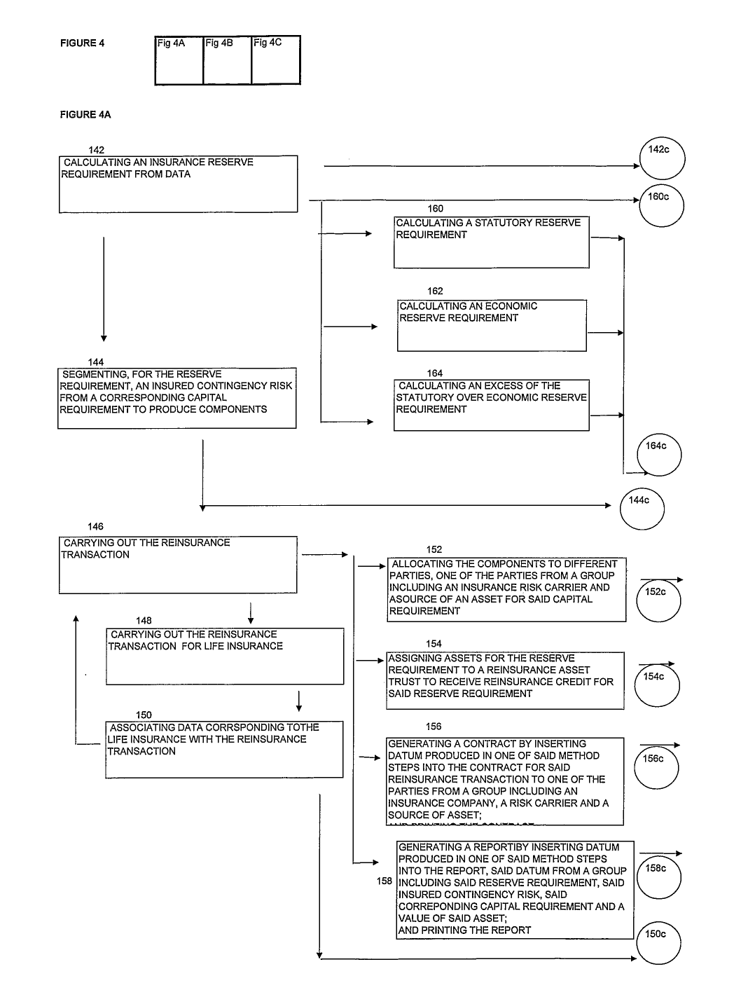

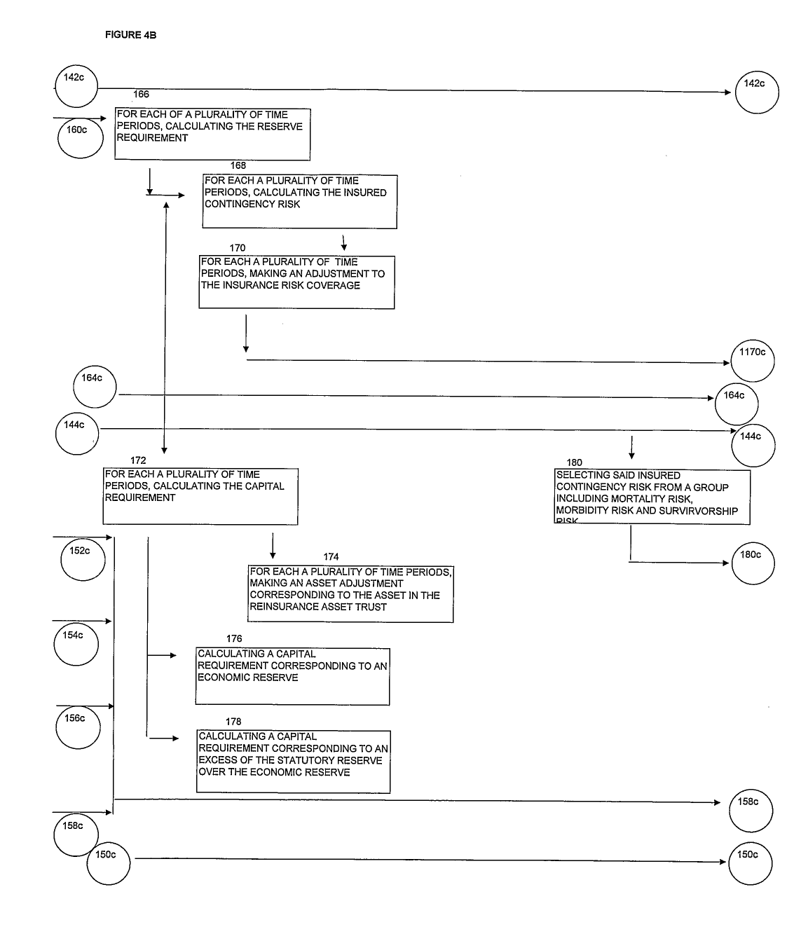

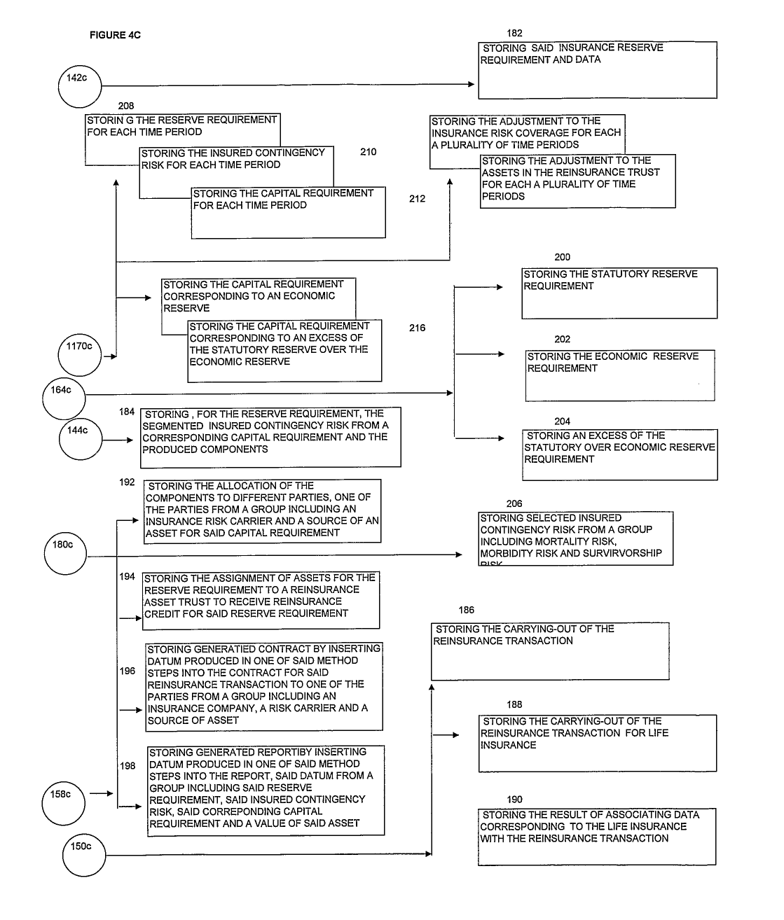

FIG. 4a-4c shows the logic of the processes in a general exemplary embodiment. Input data is received starting from the early stages of preparation for the transaction and during regular time periods for the duration of the contract.

The process includes Calculating An Insurance Reserve Requirement From Data 142, Segmenting, For The Reserve Requirement, An Insured Contingency risk, From A Corresponding Capital Requirement To Produce Components 144, Carrying Out The Reinsurance Transaction 146, Allocating The Components To Different Parties, One Of The Parties From A Group Including An Insurance Risk Carrier And A Source Of An Asset For Said Capital Requirement 152, and Assigning Assets For The Reserve Requirement To A Reinsurance Asset Trust To Receive Reinsurance Credit For Said Reserve Requirement 154. Often, the Carrying Out The Reinsurance Transaction is for Life Insurance 148 and further Associating Data Corresponding To The Life Insurance With The Reinsurance Transaction 150. Generating A Contract By inserting Datum Produced In One Of Said Method Steps Into the Contract For Said Reinsurance Transaction To One Of The Parties From A Group Including An Insurance Company, A Risk Carrier And a Source of Asset 156 and Generating A Report By Inserting Datum Produced In One Of Said Method Steps Into The Report, Said Datum From A Group Including Reserve requirement, Said Insured Contingency Risk, Said Corresponding Capital Requirement and Statutory Value Of Assets 158 also occur. Also there is Printing Of The Contract and Printing Of The Report that occur in Block 156 and Block 158, respectively.

Calculating An Insurance Reserve Requirement From Data 142 further goes into Calculating A Statutory Reserve Requirement 160, Calculating an Economic Reserve Requirement 162 and

Calculating the Excess Of Statutory Over Economic Reserve Requirement 164. Further, Selecting Said Insured Contingency Risk From A Group Including Mortality Risk, Morbidity risk And Survivorship Risk 180 also occurs.

For Each A Plurality Of Time Periods, Calculating The Reserve Requirement 166 further includes Calculating The Insured Contingency Risk 168 and Making An Adjustment To The Insurance Risk Coverage 170, and Calculating the Capital Requirement 172 and Making Adjustment An Asset Adjustment Corresponding To The Assets In The Reinsurance Asset Trust 174. Calculating The Capital Requirement 172 also involves Calculating A Capital Requirement Corresponding To An Economic Reserve 176 and Corresponding To An Excess Of The Statutory Reserve Over The Economic Reserve 178.

Input Data 34 and results of the above processes are stored through Blocks 182-208 (data; reserve requirements, statutory, economic and excess; selected insurance contingency risk; carrying out of the reinsurance transaction, including for life insurance; capital requirement corresponding to an economic reserve and the excess; the segmentation; allocation of the components to different parties; assignment of assets; the contract; and the report).

An Embodiment for Funding the Capital Requirement by Issuing a Security

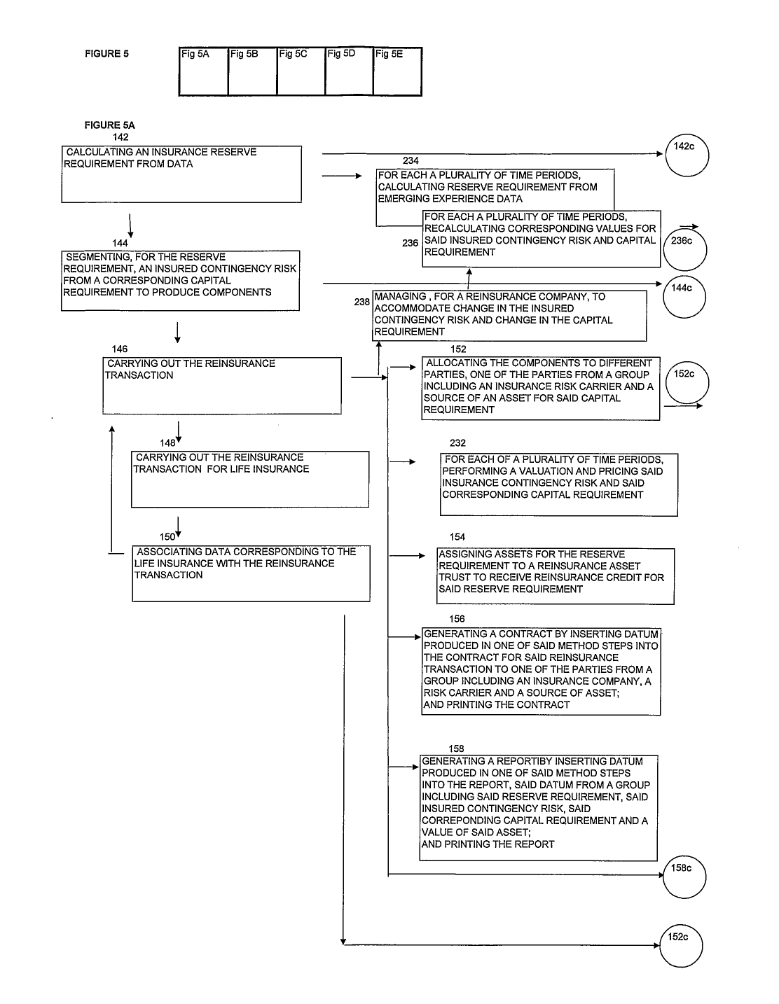

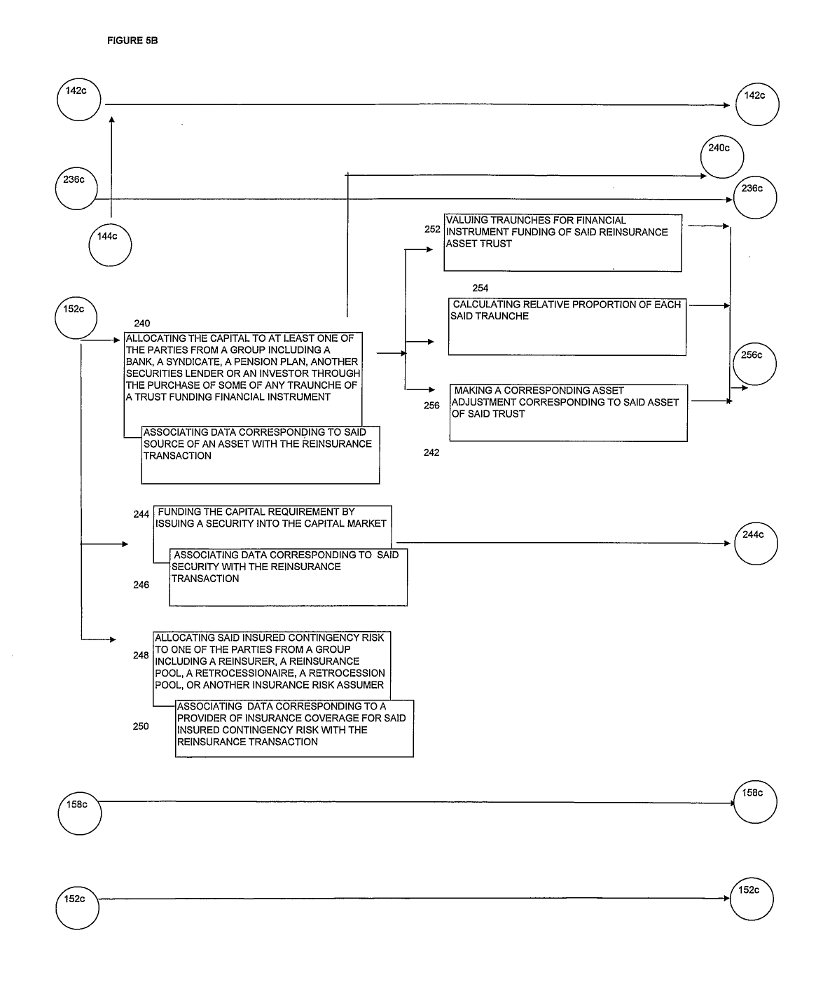

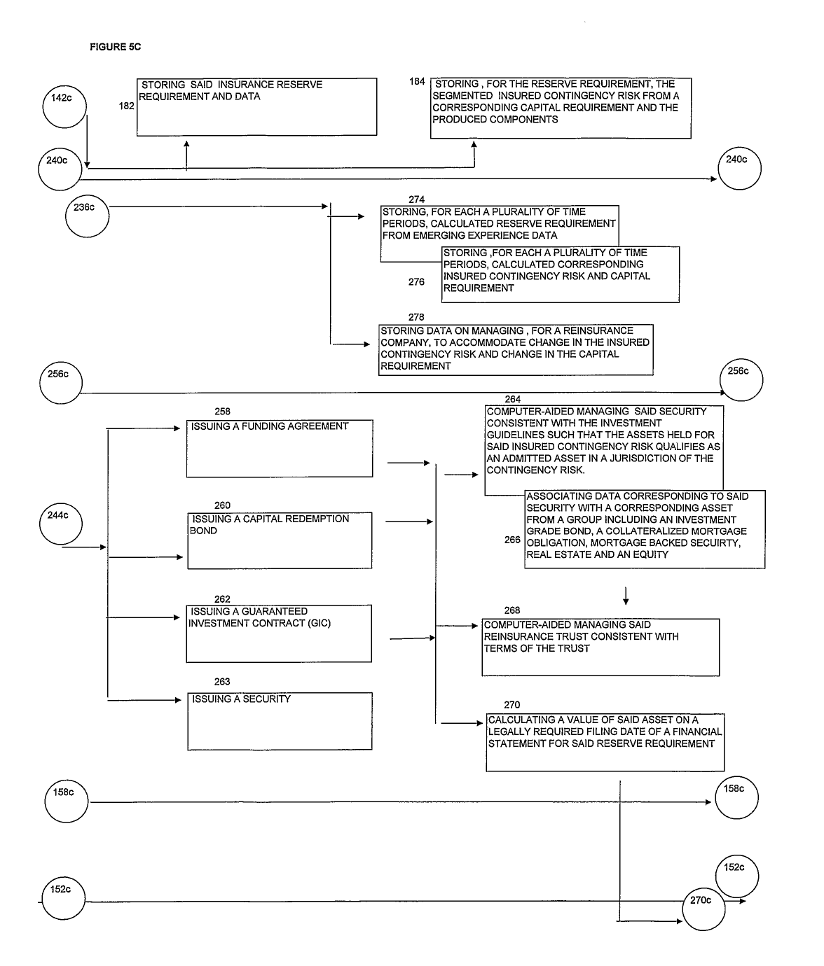

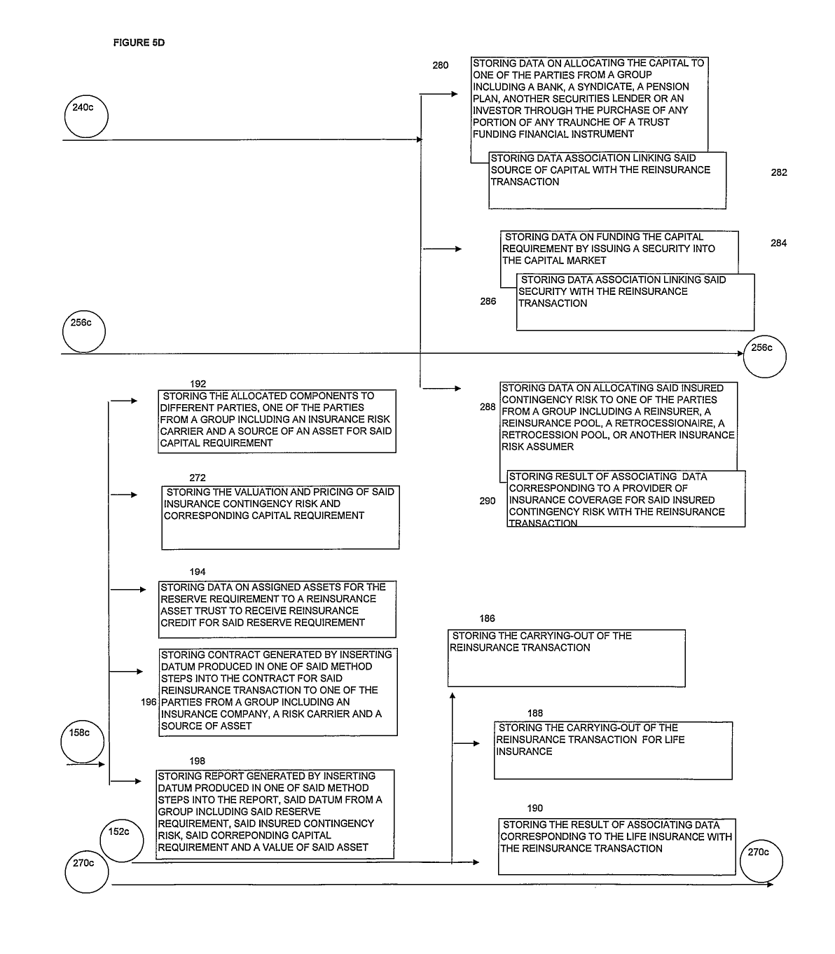

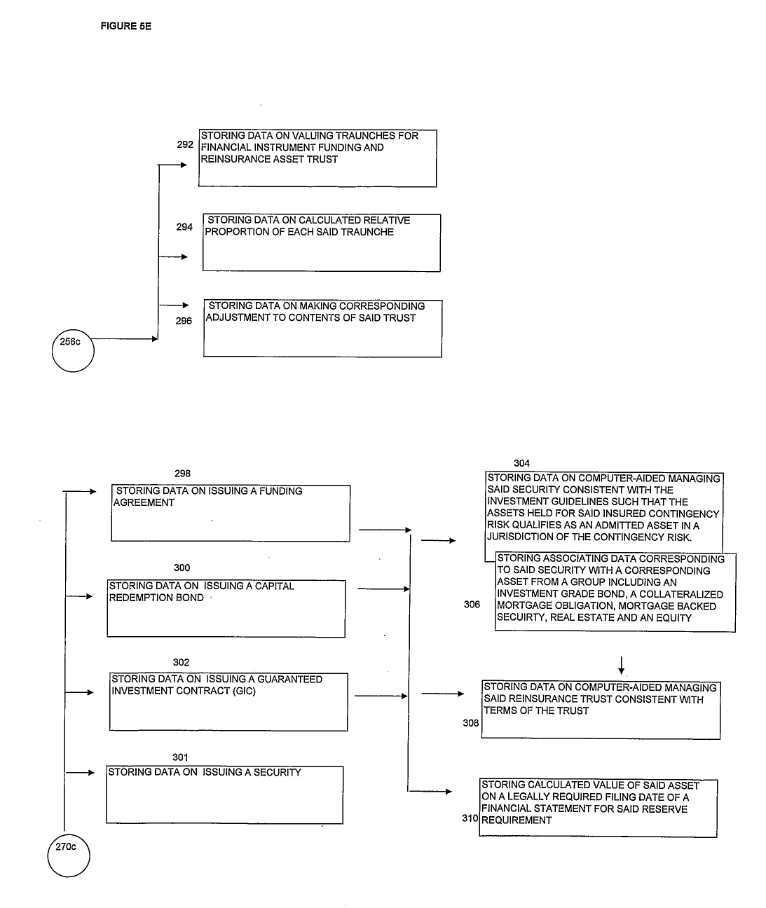

FIG. 5a-5e shows the logic of the processes in the embodiment of an embodiment for funding the capital requirement by issuing a security.

In this embodiment, Calculating An Insurance Reserve Requirement From Data 142, further involves For Each Time Period, Calculating Reserve Requirement From Emerging Experience Data 234 and For Each Time Period, Calculating Corresponding Insured Contingency Risk and Capital Requirement 236.

The Segmenting, For the Reserve Requirement 144, Carrying out The Reinsurance Transaction 146 are carried further For Life Insurance 148, Associating Data Corresponding To The Life Insurance 150, Allocating the Components 152, Assigning Assets For the Reserve Requirement 154, Generating a Contract 156 and Generating a Report 156. Additionally, there is Managing, for A Reinsurance Company 238, the Allocating The Capital To One Of the Parties From A Group Including a Bank, A Syndicate, A Pension Plan, Another Securities Lender Or An Investor Through The Purchase Of Some Of Any Traunche Of A Trust Funding Financial Instrument 240, Associating Data Corresponding To Said Source Of Asset With The Reinsurance Transaction 242, Funding The Capital Requirement By Issuing a Security Into the Capital Market 244, again Associating Data Corresponding To Said Security With The Reinsurance Transaction 246, and Allocating Said Insured Contingency Risk To One Of The Parties From a Group Including A Reinsurer, A Reinsurance Pool, A Retrocessionaire, A Retrocession Pool, Or Another Insurance Risk Assumer 248 and again Associating Data Corresponding To A Provider Of Insurance Coverage for Said Insured Contingency Risk With The Reinsurance Transaction 250

Involved in the Allocating The Capital 240 is Valuing Traunches For Financial Instrument Funding Said Reinsurance Asset Trust 252, Calculating Relative Proportion of Each Said Traunche 254 and Making A n Asset Adjustment corresponding To the Asset In The Reinsurance Asset Trust 256. Then there is the Issuing Of A Funding Agreement 258, the Issuing Of A Capital Redemption Bond 260, the Issuing Of A Guaranteed Investment Contract (GIC) 262, and the Issuing Of A Security 263. Further to the issuing of securities are Computer-aided Managing Said Security consistent with The Investment Guideline Such that the Assets Held for Said Insured Contingency Risk Qualifies As An Admitted Asset In A Jurisdiction Of The Contingency Risk 264, Associating Data corresponding to Said Security with Corresponding Asset From A Group Including investment Grade Bonds, Collateralized Mortgage Obligation, Mortgage Backed Security, Real Estate And Equities 266, Computer-aided Managing Said Reinsurance Trust consistent With Terms Of The Trust 268 and Calculating The Value Of Said Asset On a Legally Required filing Date Of A Financial Statement For Said Reserve Requirement 270.

All input data and data resulting from the logic processes are stored in the computer with steps indicated in Blocks 182-198, and Blocks 274-310. Stored are data, reserve requirement, segmented components, reinsurance transaction, details for life insurance, data association linking life insurance, allocated components, valuation and pricing, assigned assets, contract and report for the transaction. Further stored are reserve requirement from emerging experience, corresponding insured contingency risk and capital requirement, management by a reinsurance company, allocating capital to one of the parties, data association linking said source of capital, issuance of the security, data association linking said security, allocating said insurance contingency risk to one of the parties, its data association, valuing traunches, relative proportion of each said traunche, adjustment to contents of said trust, ‘funding agreement’, ‘capital redemption bond’, ‘guaranteed investment contract’, security, investment guidelines to qualify as admitted assets, types of investments, terms of the trust and statutory values of said assets

Reinsurance reserve requirements vary from period to period based upon emerging experience. As such, reserve requirements also change based upon the experience. In addition, values of reinsurance reserves trusts are calculated using market values of the securities on the date of the financial statements currently filed. Maintaining the appropriate levels of investments contained in the reinsurance trusts requires a myriad of interrelated detailed calculations to determine the amounts to be added or removed from the trusts each reporting period, usually the calendar quarter.

The reinsurance transaction requirement is to find an appropriate asset source(s), an appropriate insurance risk assumer(s), an appropriate unauthorized reinsurer, and an appropriate ceding insurance company(s).

Once done, the business to be reinsured can be evaluated and priced, both economically and statutorily, using electronic computer based pricing programs; the appropriate insurance risk premiums can be calculated; the expected reserve requirements can be calculated using electronic computer analysis of inputted data; the value of the economic and excess reserves can be calculated by operating electronic computer programs (for example) to determine the value suitable for the trust; should multiple traunches of trust funding financial instruments be necessary the relative proportions of each traunche can be calculated using proprietary risk analysis software and these calculations can be made at the end of each reporting period (usually every 90 days), with appropriate adjustment to the contents of the trust(s).

The computer systems can also produce periodic reports (at least quarterly) on current reserve requirements, current trust values, current trust value requirements and reinsurance premiums and claims for the period.

In addition, the computer-based systems can produce all contracts between the participating parties.

A Reinsurance Company Managing the Reinsurance Transaction

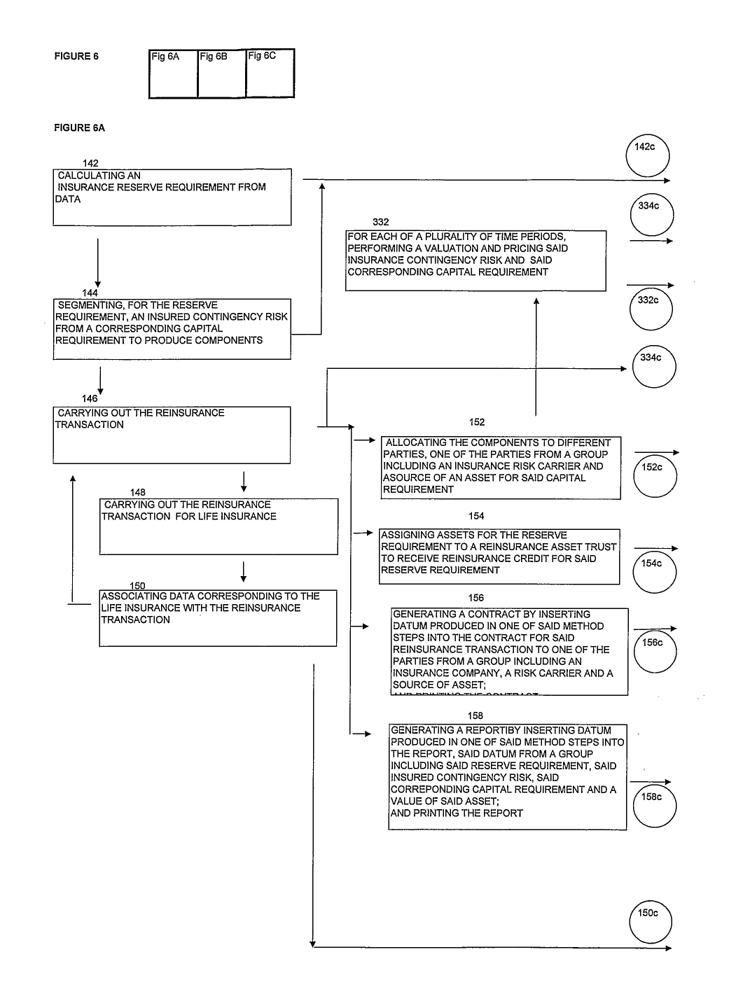

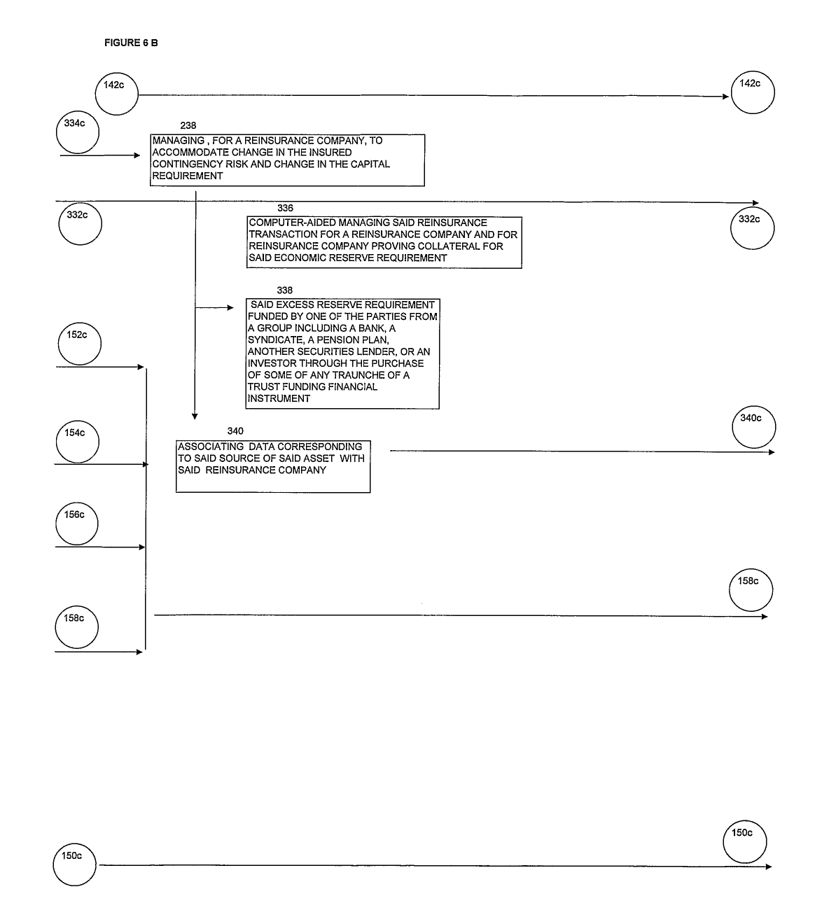

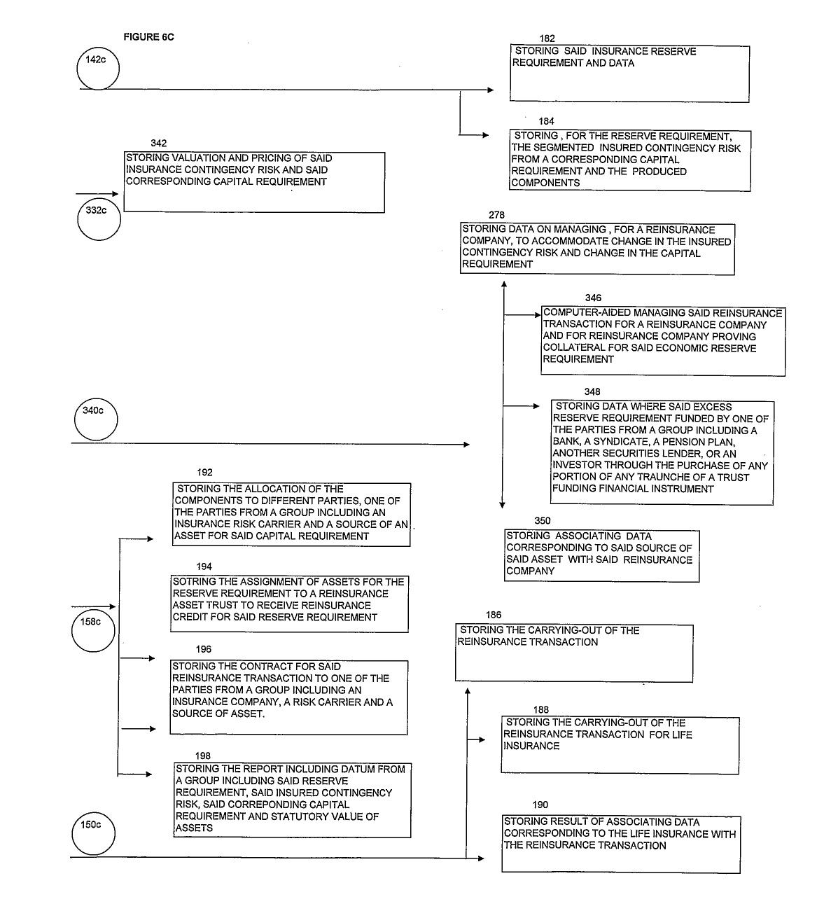

FIG. 6a-6c shows the logic of the processes in an embodiment as applied with a reinsurance company managing the reinsurance transaction. exposures.

For example, this approach can be used to manage the fluctuating reserve requirements under Guideline XXX for establishing statutory reserves for guaranteed level premium products (both term and universal life) in the U.S. Life Insurance market. In some jurisdictions, the reinsurer is only required to post economic reserves. A Reinsurance Company can segment the insurance risks from the capital requirements and manage each risk component with the most efficient party. The insurance risks can be moved to a Reinsurer (s), Retrocessionnaire (s), a Retrocession Pool, or another insurance risk assumer. The capital requirements can be funded thru a Bank, Syndicate, Pension Plan, another Securities Lender, or an investor through the purchase of any portion of any traunche of trust funding financial instruments. As such the ceding Life Insurance Company can receive the mortality risk protection as well as the collateral and related reinsurance credit for the economic reserve and the credit for the redundant reserves, as well as the reinsurance credit for the Statutory Risk Based Capital efficiently thru the Reinsurance Company.

As in the general embodiment, the process includes calculating insurance reserve requirement Block 142, segmenting an insured contingency risk from a corresponding capital requirement Block 144, carrying out the reinsurance transaction Block 146 for life insurance Blocks 148-150, allocating components Block 152, assigning assets Block 154 and the reports and contracts Blocks 156-158. Additional steps would include Managing, For A Reinsurance Company 238, with Said Reinsurance Company Providing Collateral for Said Economic Reserve Requirement 336 and for Said Excess reserve Requirement Funded By One Of the Parties From A Group Including A Bank, A Syndicate, A Pension Plan, Another Securities lender, Or An Investor Through The Purchase Of Some Of Any Traunche Of A Trust Funding Financial Instrument 338. Again also Associating Data Corresponding To Said Source Of Asset With Said Reinsurance Company 340.

Blocks 182-198 stores data and processed results in the general embodiment and Blocks 342-350 additionally stores results where the reinsurance transaction is managed by a reinsurance company. The later data includes valuation and pricing, management of reinsurance transaction, reinsurance company providing collateral for economic reserve, excess reserve from a source of capital and data association with source of capital and reinsurance company.

Network of Computer Systems

FIG. 7 shows the network of computer systems held together by computer systems Block 32, with back and forth communications mainly linked by financial analysis output Block 56 and processed documents Block 58, involving the computer systems of interested and involved parties, systems 372-388, to enumerate a few. These parties are insurance company, reinsurance company, insurance risk assumer, source of an asset, reinsurance asset trust, special purpose vehicle, advisors, consultants and regulatory bodies. In this manner, each computer serves as a transmitter with another computer serving as a receiver.

A Funding Agreement

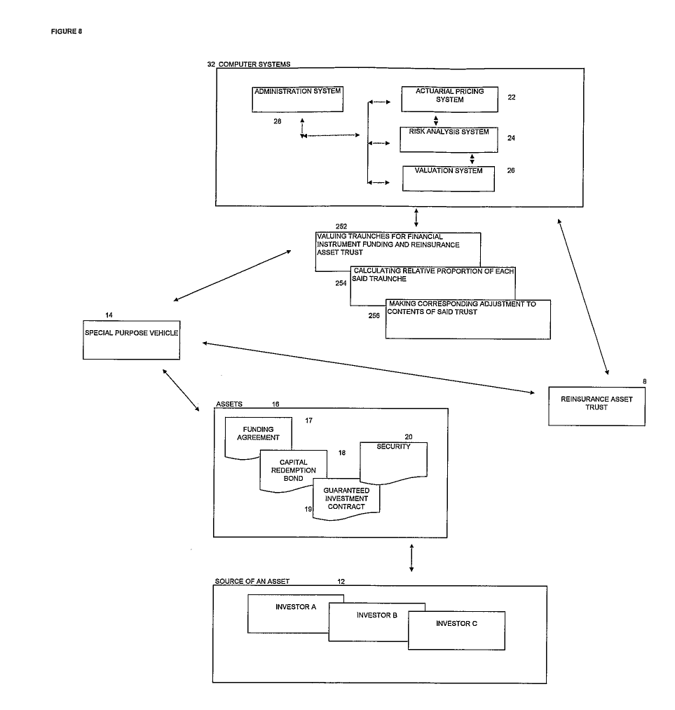

FIG. 8 is a graphic representation of a funding agreement in accordance with an embodiment. FIG. 8 shows, in summary fashion, a representative embodiment in connection with a funding agreement issued by a special purpose vehicle Block 14 tapping such assets Block 16 as a funding agreement Block 17, a capital redemption bond Block 18, a guaranteed investment income contract Block 19, and a security Block 20, all being managed under the guidelines of the admitted assets requirements for statutory regulations and also tapping into source of an asset Block 12, multiple layers of investors via traunches. Note the computer systems Block 32 with its Administration System Block 28, Actuarial Pricing System 22, proprietary Risk Analysis System 24 and Valuation System 26. The assets are assigned to a Reinsurance Asset Trust 8 to allow the insurance company to get credit for the reserve requirement.

A Special Embodiment

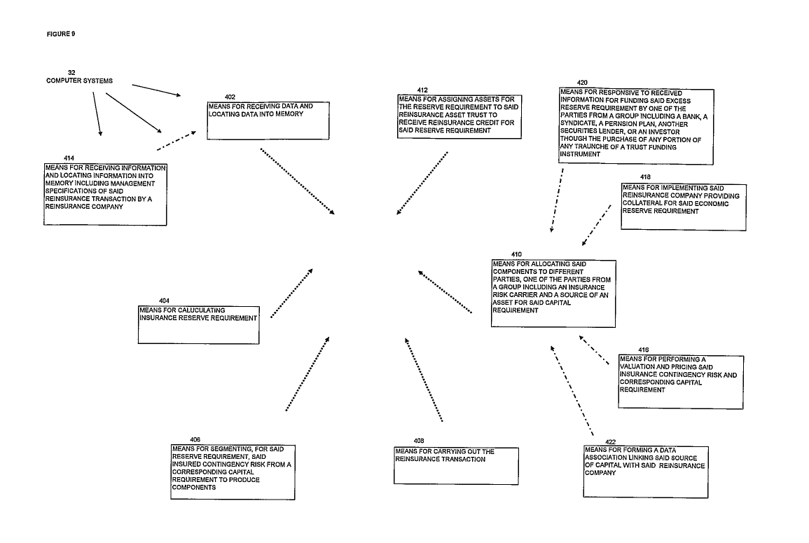

FIG. 9 illustrates a flowchart for an embodiment showing how the process with the computer system provides for means for receiving data and locating data into memory Block 402, means for calculating reserve requirements Block 404, means for segmenting reserve requirements Block 406, means for carrying out the reinsurance transaction Block 408, means for allocating said components to different parties Block 410, and means for assigning assets for the reserve requirements Block 412. The process and the computer support also provide means for further receiving data including management specifications of said reinsurance transaction by a reinsurance company Block 414. Additional means for include, means for performing a valuation and pricing Block 416, means for reinsurance company providing collateral for economic reserve Block 418, means for funding excess reserve requirement from one of the parties Block 420 and means for forming a data association linking source of capital to reinsurance company Block 422.

Additional Embodiments

In addition to corresponding methods of making and using, as well as necessary data intermediates and products produced in various embodiments, to understand permutations, consider an apparatus for controlling a system carrying out an implementation of managing an insurance reserve requirement by segmenting risk components in a reinsurance transaction. The apparatus can include: means for calculating an insurance reserve requirement from data; means for segmenting, for the reserve requirement, an insured contingency risk from a corresponding capital requirement to produce components; and means for computer-aided carrying out the reinsurance transaction by steps including: means for computer-aided allocating the components to different parties, one of the parties from a group including an insurance risk carrier and a source of an asset for said capital requirement; and means for computer-aided assigning assets for the reserve requirement to a reinsurance asset trust to receive reinsurance credit for said reserve requirement.

For this or any aspect thereof, there can be a computer-readable media tangibly embodying a program of instructions executable by a computer to perform the steps of: calculating an insurance reserve requirement from data; segmenting, for the reserve requirement, an insured contingency risk from a corresponding capital requirement to produce components; and processing data to carrying out the reinsurance transaction in which the components are allocated to different parties, one of the parties from a group including an insurance risk carrier and a source of an asset for said capital requirement and the assets for the reserve requirement are assigned to a reinsurance asset trust to receive reinsurance credit for said reserve requirement.

Viewed alternatively, there can be a computer-readable media tangibly embodying a program of instructions executable by a computer to control performance of a computer system carrying out the steps of: calculating an insurance reserve requirement from data; segmenting, for the reserve requirement, an insured contingency risk from a corresponding capital requirement to produce components; and processing data to carry out the reinsurance transaction in which the components are allocated to different parties, one of the parties from a group including an insurance risk carrier and a source of an asset for said capital requirement and the assets for the reserve requirement are assigned to a reinsurance asset trust to receive reinsurance credit for said reserve requirement, to carry out managing an insurance reserve requirement by segmenting risk components in a reinsurance transaction. The media can comprise at least one of a RAM, a ROM, a disk, an ASIC, and a PROM.

From a different perspective, in understanding the robust nature of the embodiments herein, consider an electronic transmission apparatus for handling communications to implement a part of insurance reserve requirement by segmenting risk components in a reinsurance transaction, the apparatus including: in cooperation with means for calculating an insurance reserve requirement from data and means for segmenting, for the reserve requirement, an insured contingency risk from a corresponding capital requirement to produce components, in supporting the reinsurance transaction by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, program control means for generating a data set unique to the reinsurance transaction, and electronic transmission means for communicating said data set over an Internet network addressed to another computer.

From yet another perspective, consider an electronic transmission apparatus for handling communications to implement a part of insurance reserve requirement by segmenting risk components in a reinsurance transaction, the apparatus including means for calculating an insurance reserve requirement from data and means for segmenting, for the reserve requirement, an insured contingency risk from a corresponding capital requirement to produce components, both said means cooperating to produce a unique data set for the reinsurance transaction, said reinsurance transaction carried out by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, said apparatus comprising program control means for sending the data set via electronic transmission means for communicating said data set over an Internet network addressed to another computer.

Still another perspective is that of an electronic receiver apparatus for handling communications to implement a part of insurance reserve requirement by segmenting risk components in a reinsurance transaction, the apparatus cooperating with means for calculating an insurance reserve requirement from data and means for segmenting, for the reserve requirement, an insured contingency risk from a corresponding capital requirement to produce components, both said means interacting to produce a unique data set for the reinsurance transaction, said reinsurance transaction carried out by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, said apparatus comprising program control means for receiving the data set via electronic transmission means for communicating said data set over an Internet network.

In sum, appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

We claim:

1. A computer-aided method for managing an insurance reserve requirement by segmenting risk components in a reinsurance transaction, the method including the steps of:
controlling performance of a computer system with control means in carrying out the steps of:
calculating an insurance reserve requirement from data; and
segmenting, for the reserve requirement, an insured contingency risk from a corresponding capital requirement to produce components; and
carrying out the reinsurance transaction by steps including:
allocating the components to different parties, one of the parties from a group including an insurance risk carrier and a source of an asset for said capital requirement; and
assigning assets for the reserve requirement to a reinsurance asset trust to receive reinsurance credit for said reserve requirement.

2. The method of claim 1, wherein said reinsurance transaction provides reinsurance for life insurance, and further including the step of associating data corresponding to the life insurance with the reinsurance transaction.

3. The method of claim 2, wherein said step of segmenting includes:
selecting said insured contingency risk from a group including mortality risk, morbidity risk, and survivorship risk.

4. The method of claim 2, wherein said step of calculating includes:
calculating a statutory reserve requirement;
calculating an economic reserve requirement; and
calculating an excess of the statutory over the economic reserve requirement.

5. The method of claim 2, wherein said step of segmenting includes:
calculating a capital requirement corresponding to an economic reserve; and
calculating a capital requirement corresponding to an excess of the statutory reserve over the economic reserve.

6. The method of any one of claims 1-2, wherein the step of allocating the components to different parties includes:
allocating the capital requirement to at least one of the parties from a group including a bank, a syndicate, a pension plan, another securities lender, or an investor through the purchase of some of any traunche of a trust funding financial instrument, and further including the steps of:
associating data corresponding to said source of an asset with the reinsurance transaction; and for each of a plurality of time periods:
calculating the reserve requirement and the capital requirement; and
making an asset adjustment corresponding to the asset in the reinsurance asset trust.

7. The method of claim 1, wherein the step of allocating the components to different parties includes funding the capital requirement by issuing a security into the capital market, and further including the steps of:
associating data corresponding to said security with the reinsurance transaction; and for each of a plurality of time periods:
calculating the reserve requirement and the capital requirement; and
making an asset adjustment corresponding to the asset in the reinsurance asset trust.

8. The method of claim 7, wherein said step of issuing said security into the capital market includes issuing a Funding Agreement.

9. The method of claim 7, wherein said step of issuing said security into the capital market includes issuing a Capital Redemption Bond.

10. The method of claim 7, wherein said step of issuing said security into the capital market includes issuing a Guaranteed Investment Contract.

11. The method of any one of claims 8-10, further including the step of computer-aided managing said security consistent with investment guidelines such that the asset held for said insured contingency risk qualifies as an admitted asset in a jurisdiction of the contingency risk.

12. The method of any one of claims 8-10, further including the step of associating data corresponding to said security with a corresponding asset from a group including an investment grade bond, a Collateralized Mortgage Obligation, Mortgage Backed Security, real estate, and an equity.

13. The method of any one of claims 8-10, further including the step of computer-aided managing said reinsurance asset trust consistent with terms of the trust.

14. The method of claim 11, further including the step of computer-aided managing said reinsurance asset trust consistent with terms of the trust.

15. The method of any one of claims 1-2, wherein the step of allocating the components to different parties, includes allocating said insured contingency risk to at least one of the parties from a group including a reinsurer, a reinsurance pool, a retrocessionaire, a retrocession pool, or another insurance risk assumer, and further including the steps of:
associating data corresponding to a provider of insurance coverage for said insured contingency risk with the reinsurance transaction; and for each of a plurality of time periods:
calculating the reserve requirement and the insured contingency risk; and
making an adjustment to the insurance risk coverage.

16. The method of any one of claims 1-2, further including the step of managing, for a reinsurance company, to accommodate change in the insured contingency risk and change in the capital requirement.

17. The method of any one of claims 7-10, further including, for said for said reinsurance asset trust, calculating a value of said asset on a legally required filing date of a financial statement for said reserve requirement.

18. The method of any one of claims 1-2, further including, for each of a plurality of time periods, the steps of:
calculating reserve requirement using emerging experience data; and
recalculating corresponding values for said insured contingency risk and said capital requirement.

19. The method of any one of claims 1-2, further including, for each of a plurality of time periods, the steps of:
valuing traunches for financial instrument funding of said reinsurance asset trust;
calculating relative proportion of each said traunche; and
making a corresponding asset adjustment corresponding to said asset of said trust.

20. The method of any one of claims 1-2, further including, for each of a plurality of time periods, the steps of:
generating a report by inserting datum produced in one of said method steps into the report, said datum from a group including said reserve requirement, said insured contingency risk, said corresponding capital requirement, and a value of said asset; and
printing the report.

21. The method of any one of claims 1-2, further including the steps of:
generating a contract by inserting datum produced in one of said method steps into the contract for said reinsurance transaction to one of the parties from a group including an insurance company, a risk carrier and a source of asset; and
printing the contract.

22. The method of any one of claims 1-2, further including, for each of a plurality of time periods, the step of:
performing a valuation and pricing said insurance contingency risk and said corresponding capital requirement.

23. The method of claim 22, further including the steps of:
computer-aided managing said reinsurance transaction for a reinsurance company providing collateral for said economic reserve requirement,
said excess reserve requirement funded by one of the parties from a group including a bank, a syndicate, a pension plan, a securities lender, or an investor through the purchase of any portion of any traunche of a trust funding financial instrument; and
further including the step of associating data corresponding to said source of said asset with said reinsurance company.

24. The method of claim 2, wherein the step of allocating the components to different parties further includes funding the capital requirement by issuing a security into the capital market, and further including the step of associating said security with the reinsurance transaction; and for each of a plurality of time periods:
calculating the reserve requirement and the capital requirement; and
making an asset adjustment corresponding to the asset in the reinsurance asset trust.

25. The method of claim 24, wherein said issuing said security into the capital market includes issuing a Funding Agreement.

26. The method of claim 24, wherein said issuing said security into the capital market includes issuing a Capital Redemption Bond.

27. The method of claim 24, wherein said issuing said security into the capital market includes issuing a Guaranteed Investment Contract.

28. The method of claim 12, wherein said reinsurance asset trust is managed along the statutory rules on terms of the trust.

29. The method of claim 12, further including the step of computer-aided managing said reinsurance asset trust consistent with terms of the trust.

30. The method of claim 18, further including, for each of a plurality of time periods, the steps of:
valuing traunches for financial instrument funding of said reinsurance asset trust;
calculating relative proportion of each said traunche; and
making a corresponding asset adjustment corresponding to said asset of said trust.

31. Apparatus arranged to manage a reinsurance transaction, the apparatus comprising:
a computer system arranged to arranged to manage an insurance reserve requirement by segmenting risk components in a reinsurance transaction, the computer system comprising logic means controlling the system in carrying out the steps of:
calculating an insurance reserve requirement from data; and
segmenting, for the reserve requirement, an insured contingency risk from a corresponding capital requirement to produce components, to support carrying out the reinsurance transaction in which the components are allocated to different parties, one of the parties from a group including an insurance risk carrier and a source of an asset for said capital requirement and the assets for the reserve requirement are assigned to a reinsurance asset trust to receive reinsurance credit for said reserve requirement.

32. The apparatus of claim 31, wherein said reinsurance transaction provides reinsurance for life insurance, and wherein said logic means controls the system to carry out the step of associating data corresponding to the life insurance with the reinsurance transaction.

33. The apparatus of claim 32, wherein said step of segmenting includes:
selecting said insured contingency risk from a group including mortality risk, morbidity risk, and survivorship risk.

34. The apparatus of claim 32, wherein said step of calculating includes:
calculating a statutory reserve requirement;
calculating an economic reserve requirement; and
calculating an excess of the statutory over the economic reserve requirement.

35. The apparatus of claim 32, wherein said step of segmenting includes:
calculating a capital requirement corresponding to an economic reserve; and
calculating a capital requirement corresponding to an excess of the statutory reserve over the economic reserve.

36. The apparatus of any one of claims 31-32, wherein the step of allocating the components to different parties includes:
allocating the capital requirement to at least one of the parties from a group including a bank, a syndicate, a pension plan, another securities lender, or an investor through the purchase of some of any traunche of a trust funding financial instrument, and wherein said logic means controls the system to carry out the steps of:
associating data corresponding to said source of an asset with the reinsurance transaction; and for each of a plurality of time periods:
calculating the reserve requirement and the capital requirement; and
making an asset adjustment corresponding to the asset in the reinsurance asset trust.

37. The apparatus of claim 31, wherein the step of allocating the components to different parties includes funding the capital requirement by issuing a security into the capital market, and said logic means controls the system to carry out the steps of:
associating data corresponding to said security with the reinsurance transaction; and for each of a plurality of time periods:
calculating the reserve requirement and the capital requirement; and
making an asset adjustment corresponding to the asset in the reinsurance asset trust.

38. The apparatus of claim 37, wherein said step of issuing said security into the capital market includes issuing a Funding Agreement.

39. The apparatus of claim 37, wherein said step of issuing said security into the capital market includes issuing a Capital Redemption Bond.

40. The apparatus of claim 37, wherein said step of issuing said security into the capital market includes issuing a Guaranteed Investment Contract.

41. The apparatus of any one of claims 38-40, wherein said logic means controls the system to carry out the step of computer-aided managing said security consistent with investment guidelines such that the asset held for said insured contingency risk qualifies as an admitted asset in a jurisdiction of the contingency risk.

42. The apparatus of any one of claims 38-40, wherein said logic means controls the system to carry out the step of associating data corresponding to said security with a corresponding asset from a group including an investment grade bond, a Collateralized Mortgage Obligation, Mortgage Backed Security, real estate, and an equity.

43. The apparatus of any one of claims 38-40, wherein said logic means controls the system to carry out the step of computer-aided managing said reinsurance asset trust consistent with terms of the trust.

44. The apparatus of claim 41, said logic means controls the system to carry out the step of computer-aided managing said reinsurance asset trust consistent with terms of the trust.

45. The apparatus of any one of claims 31-32, wherein the step of allocating the components to different parties, includes allocating said insured contingency risk to at least one of the parties from a group including a reinsurer, a reinsurance pool, a retrocessionaire, a retrocession pool, or another insurance risk assumer, and said logic means controls the system to carry out the steps of:
associating data corresponding to a provider of insurance coverage for said insured contingency risk with the reinsurance transaction; and for each of a plurality of time periods:
calculating the reserve requirement and the insured contingency risk; and
making an adjustment to the insurance risk coverage.

46. The apparatus of any one of claims 31-32, wherein said logic means controls the system to carry out the step of managing, for a reinsurance company, to accommodate change in the insured contingency risk and change in the capital requirement.

47. The apparatus of any one of claims 37-40, wherein said logic means controls the system to carry out, for said for said reinsurance asset trust, the step of calculating a value of said asset on a legally required filing date of a financial statement for said reserve requirement.

48. The apparatus of any one of claims 31-32, wherein said logic means controls the system to carry out, for each of a plurality of time periods, the steps of:
calculating reserve requirement using emerging experience data; and
recalculating corresponding values for said insured contingency risk and said capital requirement.

49. The apparatus of any one of claims 1-2, wherein said logic means controls the system to carry out, for each of a plurality of time periods, the steps of:
valuing traunches for financial instrument funding of said reinsurance asset trust;
calculating relative proportion of each said traunche; and
making a corresponding asset adjustment corresponding to said asset of said trust.

50. The apparatus of any one of claims 31-32, wherein said logic means controls the system to carry out, for each of a plurality of time periods, the steps of:
generating a report by inserting datum produced in one of said apparatus steps into the report, said datum from a group including said reserve requirement, said insured contingency risk, said corresponding capital requirement, and a value of said asset; and
printing the report.

51. The apparatus of any one of claims 31-32, wherein said logic means controls the system to carry out the steps of:
generating a contract by inserting datum produced in one of said apparatus steps into the contract for said reinsurance transaction to one of the parties from a group including an insurance company, a risk carrier and a source of asset; and
printing the contract.

52. The apparatus of any one of claims 31-32, wherein said logic means controls the system to carry out, for each of a plurality of time periods, the step of:
performing a valuation and pricing said insurance contingency risk and said corresponding capital requirement.

53. The apparatus of claim 52, wherein said logic means controls the system to carry out the steps of:
computer-aided managing said reinsurance transaction for a reinsurance company providing collateral for said economic reserve requirement,
said excess reserve requirement funded by one of the parties from a group including a bank, a syndicate, a pension plan, a securities lender, or an investor through the purchase of any portion of any traunche of a trust funding financial instrument; and
further including the step of associating data corresponding to said source of said asset with said reinsurance company.

54. The apparatus of claim 52, wherein the step of allocating the components to different parties further includes funding the capital requirement by issuing a security into the capital market, and wherein said logic means controls the system to carry out the steps of associating said security with the reinsurance transaction, and for each of a plurality of time periods:
calculating the reserve requirement and the capital requirement; and
making an asset adjustment corresponding to the asset in the reinsurance asset trust.

55. The apparatus of claim 54, wherein said issuing said security into the capital market includes issuing a Funding Agreement.

56. The apparatus of claim 54, wherein said issuing said security into the capital market includes issuing a Capital Redemption Bond.

57. The apparatus of claim 54, wherein said issuing said security into the capital market includes issuing a Guaranteed Investment Contract.

58. The apparatus of claim 52, wherein said reinsurance asset trust is managed along the statutory rules on terms of the trust.

59. The apparatus of claim 32, wherein said logic means controls the system to carry out the step of computer-aided managing said reinsurance asset trust consistent with terms of the trust.

60. The apparatus of claim 38, wherein said logic means controls the system to carry out, for each of a plurality of time periods, the steps of:
valuing traunches for financial instrument funding of said reinsurance asset trust;
calculating relative proportion of each said traunche; and
making a corresponding asset adjustment corresponding to said asset of said trust.

61. Apparatus controlling a system, the apparatus including:
means disposed for controlling a computer system carrying out an implementation of managing an insurance reserve requirement by segmenting risk components in a reinsurance transaction, the means controlling cooperation of:
means for calculating an insurance reserve requirement from data;
means for segmenting, for the reserve requirement, an insured contingency risk from a corresponding capital requirement to produce components; and
means for computer-aided carrying out the reinsurance transaction by steps including:
allocating the components to different parties, one of the parties from a group including an insurance risk carrier and a source of an asset for said capital requirement; and
assigning assets for the reserve requirement to a reinsurance asset trust to receive reinsurance credit for said reserve requirement.

62. A computer-readable media tangibly embodying a program of instructions executable by a computer carrying out the step of:
controlling performance of a computer system in carrying out the operations of:
calculating an insurance reserve requirement from data;
segmenting, for the reserve requirement, an insured contingency risk from a corresponding capital requirement to produce components; and
processing data to carrying out the reinsurance transaction in which the components are allocated to different parties, one of the parties from a group including an insurance risk carrier and a source of an asset for said capital requirement and the assets for the reserve requirement are assigned to a reinsurance asset trust to receive reinsurance credit for said reserve requirement, to carry out managing an insurance reserve requirement by segmenting risk components in a reinsurance transaction.

63. The media of claim 62, wherein the media comprises at least one of a RAM, a ROM, a disk, an ASIC, and a PROM.

64. An electronic transmission apparatus for handling communications to implement a part of insurance reserve requirement by segmenting risk components in a reinsurance transaction, the apparatus including:
in cooperation with means for calculating an insurance reserve requirement from data and means for segmenting, for the reserve requirement, an insured contingency risk from a corresponding capital requirement to produce components, in supporting the reinsurance transaction by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, program control means governing generating a data set unique to the reinsurance transaction; and
electronic transmission means for communicating said data set over an Internet network addressed to another computer.

65. An electronic transmission apparatus for handling communications to implement a part of insurance reserve requirement by segmenting risk components in a reinsurance transaction, the apparatus including means for calculating an insurance reserve requirement from data and means for segmenting, for the reserve requirement, an insured contingency risk from a corresponding capital requirement to produce components, both said means cooperating to produce a unique data set for the reinsurance transaction, said reinsurance transaction carried out by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, said apparatus comprising program control means governing sending the data set via electronic transmission means for communicating said data set over an Internet network addressed to another computer.

66. An electronic receiver apparatus for handling communications to implement a part of insurance reserve requirement by segmenting risk components in a reinsurance transaction, the apparatus cooperating with means for calculating an insurance reserve requirement from data and means for segmenting, for the reserve requirement, an insured contingency risk from a corresponding capital requirement to produce components, both said means interacting to produce a unique data set for the reinsurance transaction, said reinsurance transaction carried out by steps including allocating the components to different parties, one of the parties from a group including an insurance risk carrier and a source of an asset for said capital requirement, and assigning assets for the reserve requirement to a reinsurance asset trust to receive reinsurance credit for said reserve requirement, said apparatus comprising program control means for receiving the data set via electronic transmission means for communicating said data set over an Internet network.

67. A computer-readable media tangibly embodying a program of instructions executable by a computer carrying out the step of:
controlling performance of a computer system in carrying out the operations of:
calculating an insurance reserve requirement from data;
segmenting, for the reserve requirement, an insured contingency risk from a corresponding capital requirement to produce components; and
processing data to carrying out the reinsurance transaction in which the components are allocated to different parties, one of the parties from a group including an insurance risk carrier and a source of an asset for said capital requirement and the assets for the reserve requirement are assigned to a reinsurance asset trust to receive reinsurance credit for said reserve requirement.
